(19) United States
(12) Patent Application Publication
(10) Pub. No.: US 2010/0319661 A1
(43) Pub. Date: Dec. 23, 2010

(54) Cylinder-Mounted oil wiper for an opposed piston engine

(75) Inventor: Clark A. Klyza, San Diego, CA (US)

Correspondence Address: TERRANCE A. MEADOR;INCAPLAW, 1050 ROSCRANS STREET, SUITE K, SAN DIEGO, CA, 92106, US

(73) Assignee: Achates Power, Inc., San Diego, CA (US)

(21) Appl. No.: 12/802,134

(22) Filed: May 28, 2010

Related U.S. Application Data
(60) Provisional application No. 61/217,594, filed on Jun. 1, 2009.

(51) Int. Cl. F02B 75/28; F16J 9/00; F01B 31/10

(52) U.S. Cl. 123/51 R; 277/434; 92/158

(57) ABSTRACT

A ported cylinder for a diesel engine includes a circular groove in the bore, located on the outside of respective port. An oil wiper ring or a group of oil wiper rings is seated in the circular groove for wiping excess lubricating oil from a piston surface. A compressing ring is disposed between the oil wiper ring or group of oil wiper rings and the floor of the circular groove to urge the oil wiper rings into contact with the piston surface. An oil wiper ring construction includes a major surface with oil-conducting channels.

### RELATED APPLICATIONS

This application claims priority to US Provisional Application for Patent 61/217,594, filed Jun. 1, 2009.

### BACKGROUND

The field is internal combustion engines and more particularly is directed to a cylinder-mounted article for wiping or scraping the surface of a piston in order to limit the amount of lubricating oil in the piston/cylinder interface. In particular, the field concerns an oil wiper in the cylinder bore that is urged by a compressing ring against the piston.

In known opposed piston diesel engine constructions, the cylinders are lubricated by oil that is splashed within the engine compartment onto the surfaces of the pistons as the pistons are at least partially withdrawn from the cylinder bores. As a piston travels back into the bore, the oil is transported on the surface of the piston skirt into the bore/piston interface. However, excess oil carried in this manner across the exhaust and inlet ports will mix with scavenging air in the combustion space, reducing combustion efficiency, fouling the piston crown, and producing undesirable exhaust components. Unburnt oil will also mix in the exhaust gasses, further contaminating the combustion products.

It is known to limit the amount of oil transported across the ports and into the combustion space by means of oil wiper rings mounted in circular grooves near the open ends of the pistons, or in circular grooves in the cylinder bores, between the ports and the open ends of the cylinders. See, for example, U.S. Pat. No. 1,796,603. The former case requires a cylinder elongated sufficiently to keep the wiper rings seated between the pistons and the bores. In the latter case, the cylinder structure has to be adapted to mount the oil wiper rings into the bore grooves, and the piston rings must be mounted far enough toward the tops of the pistons to prevent contact between the piston rings and the oil wiper rings.

A piston-mounted oil wiper ring is seated in a circular groove in the piston surface and urged into contact with the cylinder bore by an expander located between the floor of the groove and an edge of the ring. The oil wiper ring has the construction of a typical piston ring and is split in order to be compressed against the expander to allow the piston to be inserted into the cylinder. When the piston is inserted, the expander tensions the oil wiper ring against the bore. As the piston moves toward bottom-dead-center during engine operation, the tensioned oil wiper ring skives or wipes excess oil from the bore below a port and sweeps it toward the open end of the cylinder. In two-cycle engines of this type, the cylinder is necessarily elongated because an oil wiper ring must remain within the bore, between the port and the open end of the cylinder, as the piston travels between top- and bottom-dead-center positions.

A cylinder-mounted oil wiper consists of a pair of rings in respective circular grooves formed in the bore of the cylinder, between a port and the open end of the cylinder. Space is provided between the rings in order to equalize pressure between the exhaust port and the engine crankcase which would otherwise cause the oil to flow across the rings, toward the exhaust port.

Another cylinder-mounted oil wiper includes an oil wiper ring disposed in a circular groove formed in the bore of the cylinder. The oil wiper ring typically is an elastomeric article with sufficient size and flexibility to tension itself between the groove and the piston skirt. The elastomeric materials of which such rings are constructed may not be durable enough to ensure adequate operational lifetimes and they may require frequent replacement

It is desirable to provide a ported cylinder for a two stroke engine with at least one oil wiper ring mounted in the cylinder bore to effectively wipe lubricating oil from between the contacting surfaces of the piston and cylinder. This construction allows a shorter piston that can be substantially withdrawn from the cylinder for splash-lubrication during engine operation. It is especially desirable that the oil wiper be more durable than cylinder-mounted elastomeric oil wipers. It is also desirable that cylinder-mounted oil wipers not add to the length of the cylinder which necessarily extends the length of the engine.

### SUMMARY

A ported cylinder for a diesel engine includes a circular groove in the bore, located on the outside of a respective port. An oil wiper ring or a group of oil wiper rings is seated in the circular groove for wiping excess lubricating oil from a surface of a piston in the bore. A compressing ring disposed between the oil wiper ring or group of oil wiper rings and the floor of the circular groove urges the oil wiper ring or group of oil wiper rings into contact with the piston surface. Each oil wiper ring has a major surface with oil-conducting channels. One or more elongate grooves may be provided in the cylinder bore to conduct oil from the circular groove.

The edge of an oil wiper ring which contacts the side surface of a piston may have a shape including a land that carries excess oil wiped from the piston toward the oil-conducting channels into the circular groove.

### BRIEF DESCRIPTION OF THE DRAWINGS

FIG. 1 is a shallow perspective view of an oil wiper ring assembly.

FIG. 2 is a shallow perspective view of the oil wiper ring assembly with a portion cut away to show details.

FIG. 3 is an exploded view of a cylinder liner including removable ends.

FIG. 4 is a perspective view of the assembled cylinder liner with a section cut away to show details.

FIG. 5 is a magnified sectional view showing an oil wiper ring assembly seated in a circular groove in the bore of the cylinder liner.

FIG. 6 is a magnified side sectional view of the assembled cylinder showing details of the oil wiper ring assembly.

FIG. 7 is a side sectional view of the exhaust side of a cylinder liner showing the position of a wiper with respect to a piston at TDC in the cylinder liner.

FIG. 8 is a side sectional view of the exhaust side of the cylinder liner showing the position of the wiper with respect to the piston at BDC in the cylinder liner.

### DETAILED DESCRIPTION OF THE PREFERRED EMBODIMENTS

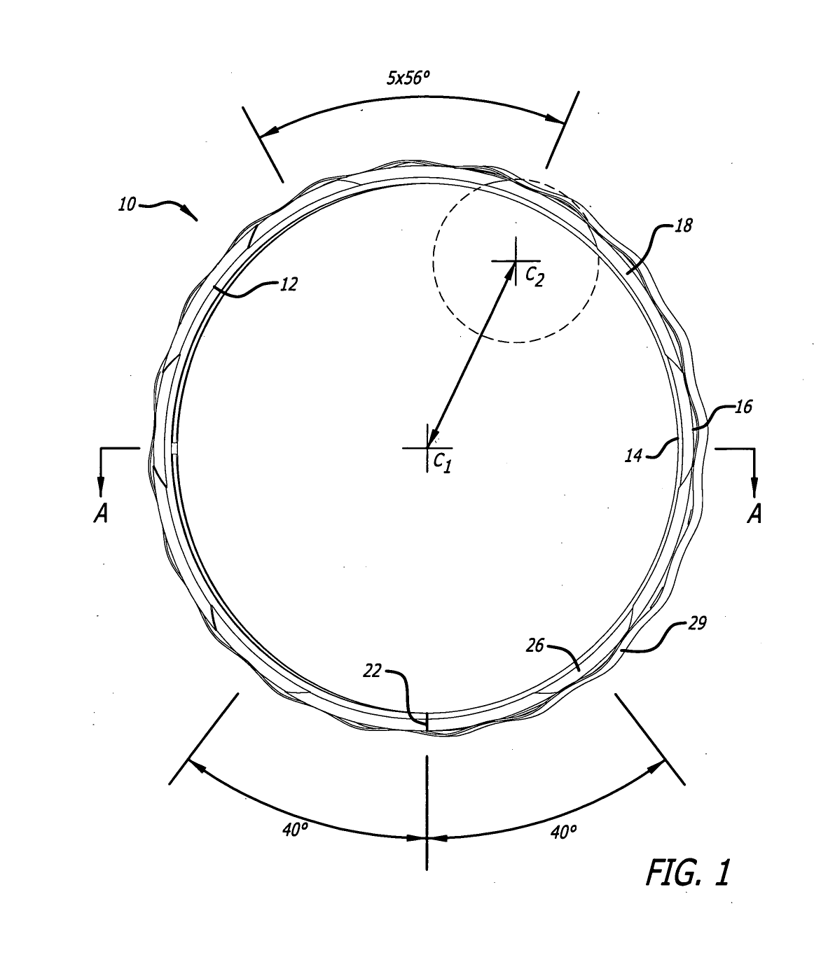

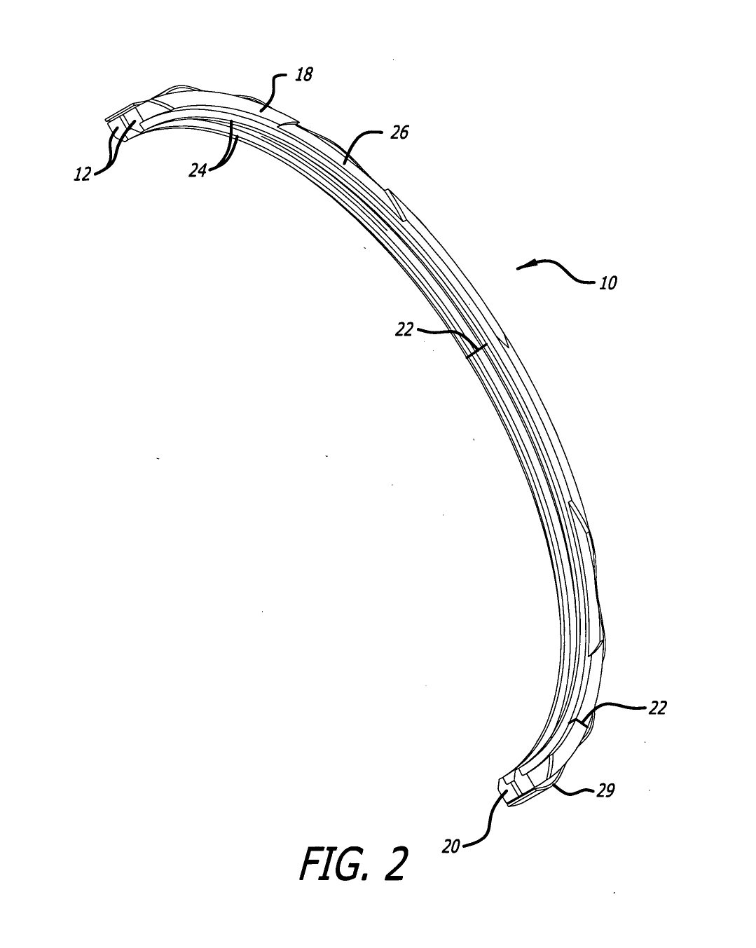

Referring to FIGS. 1 and 2, an oil wiper ring assembly 10 may include an oil wiper ring 12 or a group of oil wiper rings 12. For example, the oil wiper ring assembly 10 includes a group of two oil wiper rings 12. Each oil wiper ring 12 has inner and outer edges 14 and 16, and opposing major surfaces 18 and 20. Preferably each oil wiper ring is gapped at 22 in order to be compressed. A land 24 is formed on each inner edge 14 to contact and wipe oil from the side surface of a piston. Channels 26, preferably in the form of shallow cutouts, are formed in the major surfaces 18. No channels are formed in the major surfaces 20, which are planar. Oil wiped by the lands 24 flows in the channels 26, from the inner to the outer edges 14, 16. A wavy compressing ring 29 contacts the outer edges 16 to exert a spring force that compresses the oil wiper rings 12.

In a design example for a preferred embodiment, the oil wiper rings 12 may have an outer diameter of 85.300 mm (center to outer edge) and an inner diameter of 80.000 mm+1-0.050 mm (center C₁ to inner edge) and may be machined to a width of 2.250 mm+1-0.050 mm (major surface to major surface). The oil wiper rings 12 may be made of a cast iron material which may include a surface plating or finish. Alternately, the oil wiper rings may be made of a hard, durable, semi-rigid plastic material such as Teflon. The lands 24 may be formed by machining metal rings, or by molding and then finishing plastic rings. Six oil-conducting channels 26 may be formed in each major surface 18. These channels may be formed by machining metal rings, or by molding and then finishing plastic rings. As per FIG. 1, these channels 26 may be formed by cutting or molding portions of 28.0 mm+1-0.5 mm diameter circles in each major surface 18. Each of these cut or molded circles may have a center C₂ located 30.0 mm+1-0.5 mm from the center C₁ of an oil wiper ring 12. Four of the six channels 26 may be preferably spaced 56° apart, center-to-center, around the major surface 18 of an oil wiper ring 12, and one pair of channels 26 may be spaced 80° apart, center-to-center, on either side of the gap 22. The compressing ring 29 may be made, for example, using a stainless steel linear expander such as is available from Smalley® Steel Ring Company. The linear expander has a wavy or corrugated shape and may be formed into a wavy or corrugated compressing ring.

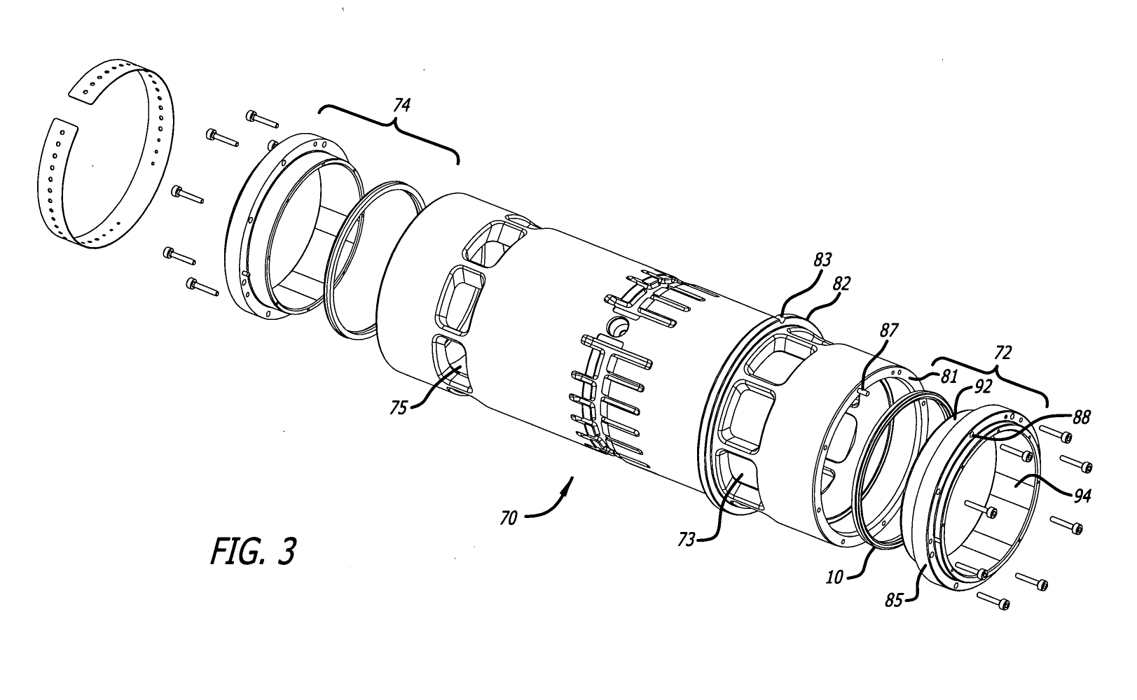

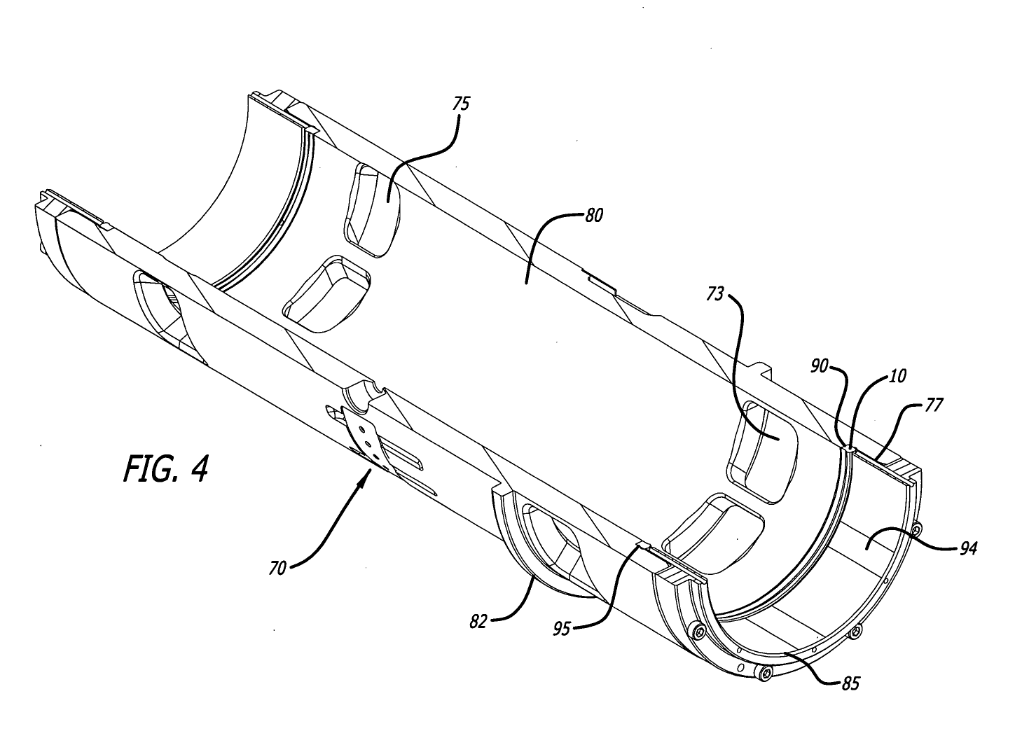

A cylinder liner 70 for an opposed piston engine is shown in FIGS. 3 and 4. The cylinder liner 70 includes exhaust and inlet ends 72 and 74 and corresponding exhaust and inlet ports 73 and 75. The cylinder liner 70 includes a liner tube 80 with end rims 81 in which the exhaust and inlet ports 73 and 75 are formed. A circumferential flange 82 with an alignment notch 83 may be provided to align and seat the cylinder liner 70 in the opposed piston engine. The exhaust end 72 is constituted of an end cap 85 that is aligned with a rim 81 by pin 87/hole 88 and is attached to the end rim 81 by threaded screws or bolts. At the exhaust end 72, the internal bore 77 of the liner tube 80 has an increased internal diameter, forming a raised shoulder 90 displaced longitudinally into the liner from the exhaust end 72. The outer diameter of the end cap 85 is reduced around its inner end 92, and the rim of the inner end 92 is received through the end rim 81 of the liner tube 80. When the end cap 85 is attached to the end rim 81, the inner end 92 is positioned just short of the raised shoulder 90, forming a circular groove 95 (FIG. 4) wherein an oil wiper assembly 10 is received and retained. With reference to FIG. 4, the groove 95 and oil wiper assembly 10 are located in the internal bore 77 of the cylinder liner, between the exhaust end 72 and exhaust port 73. The displacement between the groove 95 and the port 73 defines an annular area where compression rings, mounted to the crown of a piston, are located when the piston is at bottom-dead-center (BDC) during engine operation. Longitudinal oil discharge grooves 94 may be formed on the inside surface of the end cap's bore. Preferably, the discharge grooves 94 extend from the circular groove 95 to the outside rim of the end cap 85. The inlet end 74 may be similarly constructed, and a circular groove 95 and oil wiper assembly 10 are located in the internal bore of the cylinder liner 70, between the inlet port 75 and the inlet end 74 of the cylinder liner 70. In some aspects, the discharge grooves 94 can be replaced with discharge passages bored through the end cap to the circular groove 95.

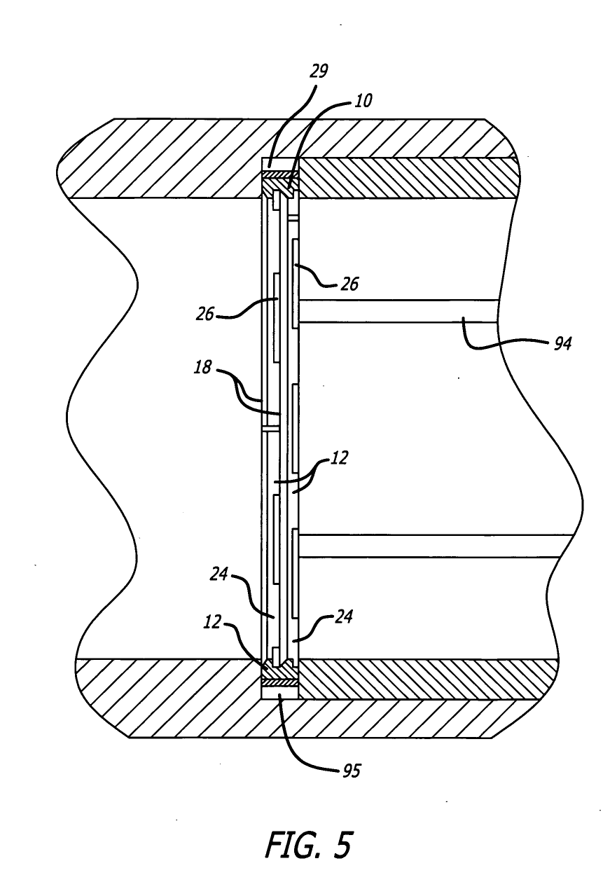

As per FIG. 5, an oil wiper ring assembly 10 with a group of two oil wiper rings 12 may be mounted in a circular groove 95 with the compressing spring 29 disposed between the floor of the circular groove 95 and the oil wiper rings. The oil wiper rings are disposed in an abutting concentric relationship with their major surfaces 18 and the channels 26 facing in a direction toward a respective end of the cylinder liner 70. The compressing spring 29 is in compressing contact with the outer edges of the oil wiper rings 12. Oil wiped by the lands 24 travels downwardly to the major surfaces 18 and through the channels 26 to the floor of the circular groove 95. From the circular groove 95, the oil flows into the longitudinal grooves 94 and out the end of the cylinder liner 70.

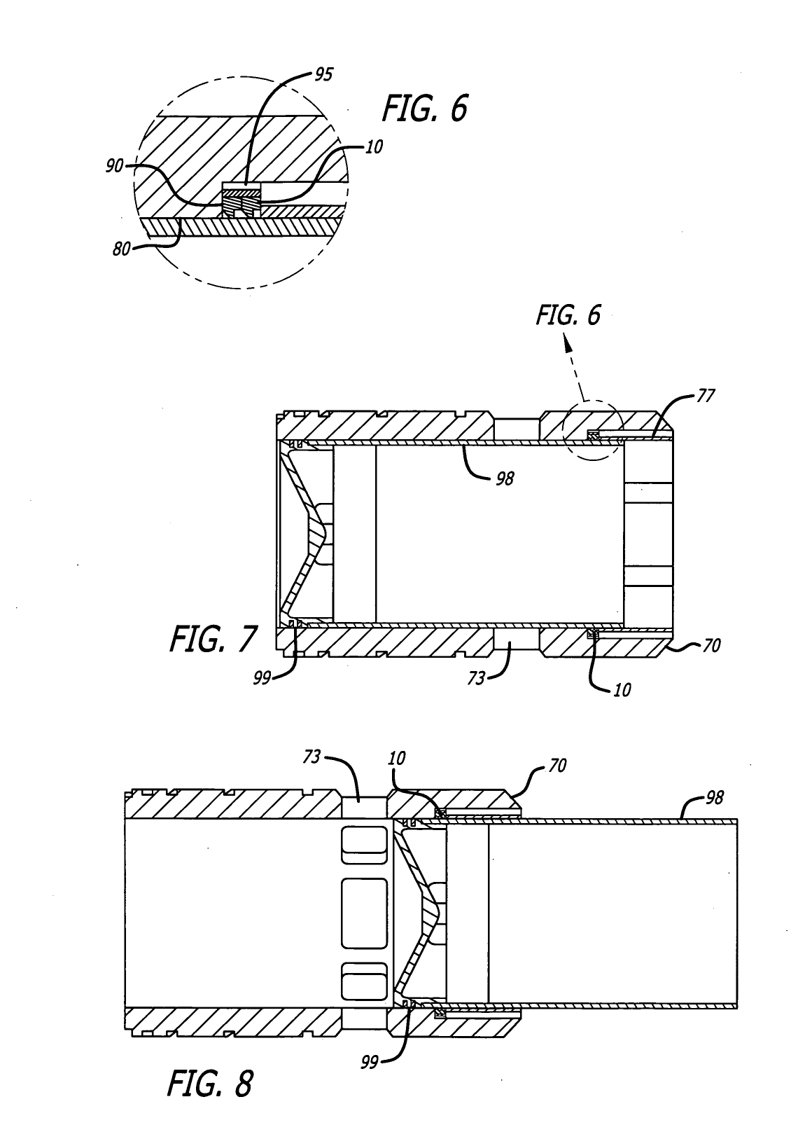

As shown in FIG. 6 when an end cap is secured to the end of the liner tube 80, the oil wiper ring assembly 10 is lodged in the circular groove 95 between the inner end of the end cap 85 and the raised shoulder 90. The compressing spring 29 exerts a force against the outer edges 16, which compresses the oil wiper rings 12 and urges the lands 24 into contact with the skirt of the piston 98. Thus seated, the lands 24 wipe excess lubricant from the skirt as the piston 98 reciprocates during engine operation. The oil wiper ring assembly 10 has a slight amount of play in the circular groove 95 which allows it to move slightly between the side walls of the circular groove 95. Thus, when the piston 98 moves into the cylinder liner, the oil wiper assembly 10 moves against the raised shoulder 90. With this inward motion of the oil wiper ring assembly 10, the major surface 20 of the inward oil wiper ring 12 seats against the raised shoulder 90 which prevents oil moving from the circular groove 95 toward the exhaust port.

With reference to FIGS. 7 and 8, the oil wiper ring assemblies 10 are located in the bore 77 so as to avoid damage by contact with the compression rings 99 while preventing the transport of lubricant on the outside surface of the piston skirts into the exhaust or inlet ports. Preferably, each oil wiper ring assembly 10 is located between an exhaust or inlet port and the corresponding end of the cylinder liner 70. This relationship is illustrated in FIG. 7, where the oil wiper ring assembly 10 is seated in the bore of the liner between the exhaust port 73 and the exhaust end 72. As the piston 98 moves through TDC, the exhaust port 73 is located between the compression rings 99 and the oil wiper ring assembly 10. In FIG. 8, when the piston 98 moves through BDC, the compression rings 99 are located between the exhaust port 73 and the oil wiper ring assembly 10. Thus, while the compression rings 99 transit the exhaust port 73 once each cycle, they do not transit the oil wiper ring assembly 10 at all.

Per FIGS. 5 and 6, a method of operating an internal combustion engine with a ported cylinder and an oil wiper ring seated in the bore of the cylinder may include compressing the oil wiper ring around a surface of a piston disposed in the bore, moving the piston in the bore, wiping oil from the piston surface with the oil wiper ring as the piston moves, draining oil wiped from the piston surface through channels in a major surface of the oil wiper ring, and draining the oil from the channels out of an end of the cylinder.

With reference to FIGS. 5-8, the internal combustion engine may be a two-stroke, opposed piston engine with one or more cylinders, each having longitudinally spaced exhaust and inlet ports. Oil wiper ring assemblies may be seated in the bore of the cylinder, each in a respective circular groove located in the bore between a respective port and an end of the cylinder. In this case, the method of operation may include compressing each oil wiper ring assembly around a surface of a piston disposed in the bore, moving the pistons in the bore, wiping oil from each piston surface with a respective oil wiper ring assembly as the piston moves, draining oil wiped from the piston surfaces through channels in the oil wiper ring assemblies, and draining the oil from the channels through longitudinal grooves in the bore out of the ends of the cylinder.

The novel articles disclosed and illustrated herein may suitably be practiced in the absence of any element or step which is not specifically disclosed in the specification, illustrated in the drawings, and/or exemplified in the embodiments of this application. Moreover, although the invention has been described with reference to preferred embodiments, it should be understood that various modifications can be made without departing from the spirit of the invention. Accordingly, the invention is limited only by the following claims.

1. An opposed piston engine comprising a cylinder with a liner, a pair of pistons disposed in opposition in the bore of the liner, an oil wiper ring disposed in the bore, between an end and a corresponding port of the liner, and a compressing ring disposed between the bore and an outer edge of the oil wiper ring.

2. The opposed piston engine of claim 1, further including a circular groove between the port and the end of the liner, wherein the compressing ring is disposed in the circular groove between the oil wiper ring and the floor of the circular groove.

3. The opposed piston engine of claim 1, further including one or more oil-conducting channels in a major surface of the oil wiper ring, extending between the outer and an inner edge of the oil wiper ring.

4. The opposed piston engine of claim 1, further including a land on an inner edge of the oil wiper ring.

5. The opposed piston engine of claim 1, wherein the compressing ring comprises a wavy expander.

6. The opposed piston engine of claim 2, further including one or more oil-conducting channels in a major surface of the oil wiper ring, extending between the outer and an inner edge of the oil wiper ring.

7. The opposed piston engine of claim 6, further including a land on an inner edge of the oil wiper ring.

8. The opposed piston engine of claim 7, wherein the compressing ring comprises a linear expander.

9. An opposed piston article, comprising:
at least one oil wiper ring with a gap, opposing major surfaces and inner and outer edges, and a land along the inner edge;
a major surface of the oil wiper ring including at least one oil conducting channel; and,
a compressing ring mounted to the outer edge to compress the oil wiper ring.

10. The opposed piston article of claim 9, wherein the compressing ring comprises a wavy expander.

11. The opposed piston article of claim 9, wherein the oil wiper ring comprises iron or a semi-rigid plastic.

12. An opposed piston article, comprising:
at least two oil wiper rings, each having a gap, opposing major surfaces, inner and outer edges, at least one oil conducting channel in a first major surface, and a land along the inner edge;
the oil wiper rings disposed in an abutting concentric relationship with their first major surfaces facing in the same direction; and,
a compressing ring in compressing contact with the outer edges to compress the oil wiper rings.

13. The opposed piston article of claim 12, wherein the compressing ring comprises a wavy expander.

14. The opposed piston article of claim 12, wherein each oil wiper ring comprises iron or a semi-rigid plastic.

15. A method of operating an internal combustion engine including a ported cylinder and a piston disposed in the bore of the cylinder, comprising:
compressing an oil wiper ring seated in the cylinder bore around a surface of the piston;
moving the piston in the cylinder bore;
wiping oil from the piston surface with the oil wiper ring as the piston moves;
draining oil wiped from the piston surface through channels in a major surface of the oil wiper ring; and,
draining the oil from the channels out of an end of the cylinder.

16. A method of operating a two-stroke, opposed piston engine with one or more cylinders, each having longitudinally spaced exhaust and inlet ports, and oil wiper ring assemblies seated in the bore of the cylinder, each in a respective circular groove located in the bore between a respective and a corresponding port of the cylinder, the method including:
compressing each oil wiper ring assembly around a surface of a piston disposed in the bore;
moving the pistons in the bore;
wiping oil from each piston surface with a respective oil wiper ring assembly;
draining oil wiped from the piston surfaces through channels in the oil wiper ring assemblies; and,
draining the oil from the channels through longitudinal grooves in the bore out of the ends of the cylinder.
